(19) United States
(12) Patent Application Publication
(10) Pub. No.: US 2025/0308239 A1
(43) Pub. Date: Oct. 2, 2025

(54) OBJECT CLASSIFICATION AND IDENTIFICATION AT POINT OF SALE

(71) Applicant: Toshiba Global Commerce Solutions, Inc., Durham, NC (US)

(72) Inventor: Leandro Morera, Jiutepec (MX)

(73) Assignee: Toshiba Global Commerce Solutions, Inc., Durham, NC (US)

(21) Appl. No.: 18/616,843

(22) Filed: Mar. 26, 2024

(51) Int. Cl. G06V 20/52; G01G 19/414; G06Q 20/20; G06V 10/764; G06V 10/774

(52) U.S. Cl. CPC G06V 20/52; G01G 19/4144; G06Q 20/208; G06V 10/764; G06V 10/774

(57) ABSTRACT

Systems and methods of performing object classification and identification at point of sale are provided. In one exemplary embodiment, a method is performed by a POS system having a load sensor and an optical sensor. The load sensor is operable to measure a load of an object while positioned on a load surface of the POS system. The optical sensor has a field of view associated with the load surface and is operable to capture an image. The method includes obtaining an image captured by the optical sensor that includes a target object and a load measurement associated with the target object performed by the load sensor while the target object is positioned on the load surface to enable object classification or identification of the target object based on object recognition of the target object from the captured image and a prediction of the target object from the load measurement.

### BACKGROUND

Retailers use point of sale (POS) hardware and software systems to streamline checkout operations and to allow retailers to process sales, handle payments, and store transactions for later retrieval. Each POS system generally includes a number of components including a POS terminal station and a POS bagging station. POS bagging stations can enable customers or retail staff to bag purchased retail items in shopping bags during checkout at the POS systems. POS terminal station devices can include a computer, a monitor, a cash drawer, a receipt printer, a customer display, a barcode scanner, or a debit/credit card reader. POS systems can also include a conveyor belt, a checkout divider, a weight scale, an integrated credit card processing system, a signature capture device, or a customer pinpad device. While POS systems may include a keyboard and mouse, more and more POS systems include monitors with touchscreen technology. Further, the software integrated with POS systems can be configured to handle a myriad of customer-based functions such as product scans, sales, returns, exchanges, layaways, gift cards, gift registries, customer loyalty programs, promotions, and discounts. In a retail environment, there can be multiple POS systems in communication with a server over a network.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates one embodiment of a POS system operable to perform object classification or identification at point of sale in accordance with various aspects as described herein.

FIG. 2 illustrates another embodiment of a POS system in accordance with various aspects as described herein.

FIG. 3 illustrates another embodiment of a POS system in accordance with various aspects as described herein.

FIG. 4 illustrates embodiment of a method performed by a POS system of performing object classification or identification at point of sale in accordance with various aspects as described herein.

FIG. 5 illustrates another embodiment of a POS system in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

Today's consumers expect as much personalization and convenience in retail stores as they experience online. With computer vision cameras, self-checkout experience becomes frictionless, while virtual mirrors enable the previously unseen level of personalization. Routine tasks can be automated with autonomous robots, leaving retail store employees more time for more customer-oriented tasks. With machine learning consulting and a holistic approach to computer vision implementation, retail digital transformation becomes much more attainable.

Furthermore, the training process for a computer vision system without a fixed distance to the visual plane produces an inconsistency in the size identification of products with the same design (e.g., product shape, packaging). For instance, with a change in the distance between a computer vision system (e.g., camera) and a retail product from one meter to two meters, the computer vision system identifies the five hundred gram (500 g) product as a two hundred fifty gram (250 g) product and the one thousand gram (1000 g) product as the five hundred gram (500 g) product. In addition, the data set in the training stage of a computer vision system is dependent on the focal distance to enable an accurate dimension (e.g., width, height, depth) identification of the retail items. This tends to be problematic for many serialized products designed with the same or similar packaging, figures and dimension proportions for different weights of those retail items.

To overcome these limitations, in one exemplary embodiment, the use of a weight measurement of a retail item by a weight scale for object recognition can enable the computer vision system to operate independent of focal distance of the computer vision system. With a combination of a retail scale (e.g., weight scale, scanner scale) working contemporaneously with a computer vision system, a computer vision system can perform focal distance independent object recognition. The focal distance independence object recognition can provide various advantages such as freedom for store organization and weight scale position, unique images database for training for any focal distance, and low complexity for object identification and unnecessary algorithms for relations of proportions. In implementing focal distance independence object recognition, one of the requirements can include the height over the plane of the product position or counter must be related with the image database employed in the training. In one exemplary embodiment, a POS system can obtain a weight measurement of a retail item from a weight scale of that POS system. Further, the POS system can obtain one or more images of that retail item from one or more cameras associated with the POS system. The POS system can then identify the retail item based on focal distance independence object recognition and the weight measurement of that retail item. A consumer can present a retail item to the POS system by placing that retail item on a surface of a weight scale such as on a scanner scale of the POS system or a weight scale surface in the bagging area of the POS system. As such, the additional time required by a consumer to search and locate a barcode on a retail item is avoided.

Focal distance independent object recognition refers to the ability of a system to recognize objects in images regardless of the focal distance at which the image was captured. Traditional image recognition systems may struggle with objects that are out of focus or at different focal distances, as the sharpness and clarity of the object can affect its features and appearance in the image. To achieve focal distance independent object recognition, a system would need to be robust to variations in focal distance and able to extract relevant features from the object regardless of its focus level. This could involve using advanced algorithms for feature extraction that are less sensitive to blur, as well as incorporating depth information to better understand the 3D structure of objects in the scene. Techniques like deep learning and convolutional neural networks (CNNs) have been applied in developing models that are robust to changes in focal distance, enabling more accurate object recognition in a variety of conditions.

Object recognition generally considers the size of an object as a confounding variable when validating object-oriented metrics. However, the ability to measure the size of an object does not temporally precede the ability to measure other object-oriented metrics. Hence, the condition that a confounding variable must occur causally prior to another explanatory variable is not met. In addition, when specifying multivariate models of defects that incorporate object-oriented metrics, entering size as an explanatory variable may result in misspecified models that lack internal consistency. For instance, the training process for a computer vision system without a fixed distance to the visual plane produces an inconsistency in the size identification of products with the same design.

Retail execution is a business process designed to ensure that the overall brand strategy of a manufacturer of consumer goods is executed in retail stores and aims to place the right product on the right shelf at the right time. Given that many retail operations require visual feedback and generate large amounts of data, interest in computer vision technology among retail companies continues to increase. According to the 29th Annual Retail Technology Study by Retail Info Systems (RIS®), only three percent (3%) of retailers have already implemented computer vision technology, with forty percent (40%) planning to implement it within the next two years. Computer vision technology is posed to tackle many retail store pain points and can potentially transform both customer and employee experiences. For instance, customer retail store experiences can be redefined by making store layout improvement decisions based on real data rather than intuition.

In this disclosure, embodiments described herein include the use of a computer vision system having focal distance independence object recognition and a weight scale to detect an object at a self-checkout station such as on a scanner scale platform of the self-checkout system or on a weight scale platform in the bagging area of the self-checkout station. When the weight of that object is detected and measured by a weight scale, the self-checkout station through the computer vison system can detect, classify or identify the object as a certain retail item based on focal distance independence object recognition and the measured weight of the object.

In another exemplary embodiment, a computer vision system can obtain a weight measurement of a retail item taken by a consumer from a weight scale surface of a retail shelving unit. Further, the computer vision system can obtain one or more images of that retail item from one or more cameras proximate the retail shelving unit. The computer vision system can then identify the retail item based on focal distance independence object recognition and the weight measurement of that retail item.

In another exemplary embodiment, a computer vision system includes CNN-based multi-region of interest (ROI) recognition and a weight scale or sensor to avoid random focal distance confusion. This computer vision system can reduce the bank of images by incorporating the weight by ROI area. Further, this computer vision system can resolve the confusion of focal independence for retail items having the same design but different scales with multi-ROI CNN segmenting specific areas and detecting with pairs (weight, recognition). As such, this system can reduce the cost of database dimensioning, making it possible to reuse databases without multiscale data augmentation. However, this system may require implementation of a calibration interface or CNN multi-ROI detection. Further, some benefits of this system can include centralizing the information processing, requiring just one camera instead of many for each POS system, reducing the space required for each POS system such as to only a touchscreen display and surrounding surface area.

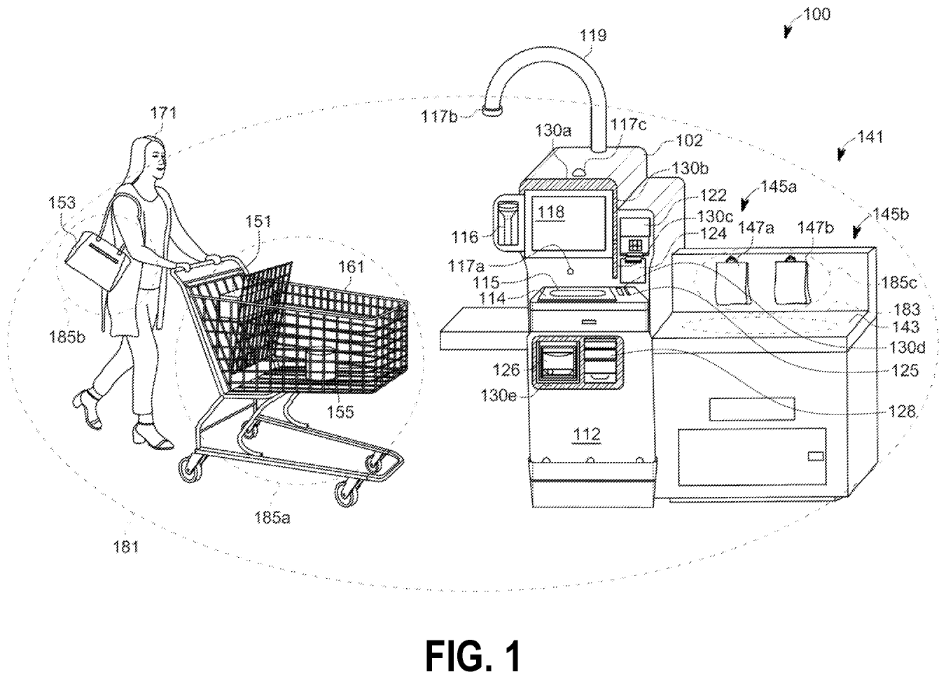

FIG. 1 illustrates one embodiment of a POS system 100 operable to perform object classification or identification at point of sale in accordance with various aspects as described herein. As shown in FIG. 1, the POS system 100 (e.g., checkout station device, self-checkout station device) can be communicatively coupled to a network node (e.g., server) over a network (e.g., Ethernet, WiFi, Internet). The network node can include edge Al technology operable to perform focal distance independent object recognition. The POS system 100 can include a terminal station device 102 and a bagging station device 141. The terminal station device 102 has a housing 112, a load surface 114 having a scanner window 115, another optical scanner 116 (e.g., portable or handheld scanner), a display device 118 (e.g., touchscreen), a payment processing mechanism 122 (e.g., credit card transaction device), a printer 124, a coupon slot mechanism 125, a cash acceptor mechanism 126, a change (e.g., coins, cash) interface mechanism 128, the like, or any combination thereof. The load surface 114 is configured to enable a load sensor device (e.g., weight scale) disposed in the POS system 100 to measure a load (e.g., weight) of an object positioned on the load surface 114. The scanner window 115 is configured to enable an optical scanner device disposed in the POS system 100 to scan a visual object identifier code (e.g., barcode, QR code) disposed on an object (e.g., retail item) through the scanner window 115.

Furthermore, the terminal station device 102 can be configured to include a set of light emitting element (LED) devices 130a-e (collectively, LED devices 130). The housing 112 can be configured to include a cabinet that contains a processing circuitry operable to control the operations and functions of the POS system 100. Each LED device 130a-e can be configured to be individually or collectively controlled by a processing circuit of the POS system 100 to indicate certain contextual information to a consumer or a retail store clerk. Although not explicitly shown herein, the housing 112 can also contain cabling and other functional components that communicatively couple the POS system 100 to a network (e.g., Ethernet, WiFi, Internet) or a network node (e.g., server) over the network or that communicatively couple the terminal station device 102 to the bagging station device 141. The bagging station apparatus 141 can include a load surface 143 (e.g., bagging area) associated with a load sensor device disposed in the bagging station apparatus 141.

In FIG. 1, each scanner device 115, 116 can be configured as an optical scanner device operable to scan a visual object identifier code (e.g., barcode, QR code) disposed on an object (e.g., retail item) that a consumer intends to purchase via the POS system 100. The scanner device 116 can be configured as a hand-held, battery-operated scanner that a consumer or a clerk can remove from its battery charging dock to scan barcodes on retail items without having to remove them from a shopping cart. Each visual object identifier code can represent one of a set of object identifiers (e.g., UPCs), with each identifier being specific to a certain object (e.g., retail item, trade item) and represented by a series of characters (e.g., numeric characters, alphabetic characters, alphanumeric characters). Universal Product Code (UPC), which can refer to UPC-A, consists of a sequence of twelve characters (e.g., 12 numeric characters) that are uniquely assigned to each object. Along with the related International Article Number (EAN) barcode, the UPC is the barcode mainly used for scanning retail items at the point of sale, per the specifications of the international GS1 organization. In one example, a UPC-A barcode consists of a sequence of twelve characters (e.g., 12 digits), which are made up of four sections: a number system character, a five-character manufacturing number, a five-character item number and a check character.

In FIG. 1, the scanner device 115 can include a scanner window and can be operable to perform dual scanner and weight scale functions to allow the retail item to be contemporaneously scanned and weighed for purchase by a consumer. The load surface 114 can be configured to allow an object to be placed on the load surface 114 to enable the object to be weighed by the weight scale function. The display 118 can be operable to display information associated with retail items being purchased by a consumer. The payment processing mechanism 122 can be configured with a pinpad device operable to accept a non-cash payment vehicle (e.g., credit card or debit card), while the printer 124 can be configured to print receipts or coupons. The coupon slot mechanism 125 can include a generally elongated slot configured to receive coupons being redeemed by a consumer. The cash acceptor mechanism 126 can be operable to receive cash (e.g., paper money, coins) from the consumer for the retail items being purchased by the consumer. The change interface mechanism 128 can be operable to provide change to the consumer in the form of paper money or coins. The terminal station device 102 can also include optical sensor devices 117a-c (e.g., camera). Each optical sensor device 117a-c can be operable to capture an image of at least a portion of the POS system 100, capture an image about the POS system 100 that includes a first region 181, capture an image of the environment surrounding the POS system 100, capture an image of one or more surfaces of the POS system 100 such as the load surface 114 or the bagging area 183, or the like. The optical sensor device 117a can have a field of view that includes the load surface 114. The optical sensor device 117b can have a field of view that includes the POS system 100, a region about the POS system 100 and the environment about the POS system 100. While the optical sensor device 117c is shown in FIG. 1 at the end of an extension mechanism 119 (e.g., pole) of the POS system 100 that extends the optical sensor device 117c above the POS system 100, in other embodiments, the optical sensor device 117c can be disposed on a ceiling surface above the POS system 100, positioned on the POS system 100, or the like. The optical sensor device 117c can be operable to capture the environment about the POS system 100 such as to detect a consumer entering the first region 181.

In operation, the POS system 100 can obtain a load measurement (e.g., weight) associated with a target object (e.g., retail item) that is performed by the load sensor device (e.g., weight scale, scanner scale) while the target object is positioned on the corresponding load surface 114, 143 (e.g., scanner scale platform, bagging area platform). For instance, processing circuitry of the POS system 100 can receive, from the load sensor device of the corresponding load surface 114, 143, an indication that includes the load measurement of the target object while positioned on that load surface 114, 143. The POS system 100 can determine that a weight change event associated with that load surface 114, 143 has occurred based on the load measurement. In response, the POS system 100 can determine to capture an image of the target object. The POS system 100 can obtain the captured image that includes a visual representation of at least a portion of the target object. For instance, the processing circuitry of the POS system 100 can send, to one or more optical sensor devices 117a-c, an indication that includes a request to capture an image. In response, the processing circuitry of the POS system 100 can receive, from the one or more optical sensor devices 117a-c, an indication that includes a captured image having a visual representation of at least a portion of the target object. The POS system 100 can then perform object recognition of the target object represented in the captured image based on the captured image(s) to obtain one or more vision-based predicted objects and corresponding vision-based confidence levels, with the object recognition being performed independent of the focal distance at which the target object was captured by the one or more optical sensor device 117a-c. Further, the POS system 100 can also predict the target object based on the weight measurement of the target object to obtain one or more weight-based predicted objects and corresponding weight-based confidence levels. In addition, the POS system 100 can perform object classification or identification of the target object based on the one or more vision-based predicted objects and the corresponding vision-based confidence levels and the one or more weight-based predicted objects and the corresponding weight-based confidence levels.

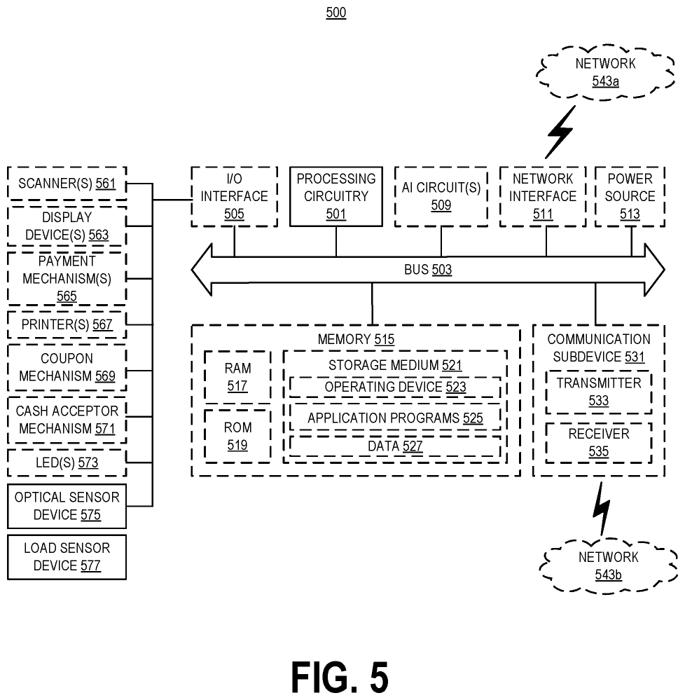

In another embodiment, the POS system 100 can send, by a processing circuit of the POS system 100, to an artificial intelligence circuit (such as Al circuit(s) 509 in FIG. 5), an indication that includes a request to perform the object recognition of the target object represented in the captured image based on the captured image, with the artificial intelligence circuit being trained on a set of training images of a certain object that is configured to enable the classification or identification of the certain object independent of the focal distance at which the certain object was captured by the optical sensor device. In response, the POS system 100 can receive, by the processing circuit of the POS system 100, from the artificial intelligence circuit, an indication that includes one or more vision-based predicted objects and corresponding vision-based confidence levels.

In another embodiment, the set of training images of the certain object are captured by an optical sensor device at a certain distance from the certain object, with the certain distance corresponding to a distance in which the optical sensor device 117a-c captures an image of the target object while positioned on the load surface 114, 143.

In another embodiment, the POS system 100 can send, to a network node having an artificial intelligence circuit (such as the network node 500 having Al circuit(s) 509 in FIG. 5), an indication that includes a request to perform the object recognition of the target object represented in the captured image based on the captured image. The artificial intelligence circuit is trained on a set of training images of a certain object. Further, the set of training images is configured to enable the object classification or identification of the certain object independent of the focal distance at which the certain object was captured by the optical sensor device. The POS system 100 can receive, by the POS system 100, from the network node, an indication that includes one or more visual-based predicted objects and corresponding visual-based confidence levels.

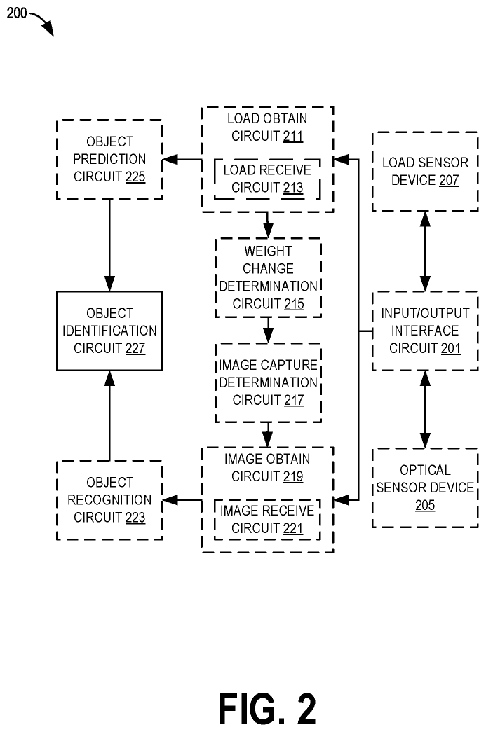

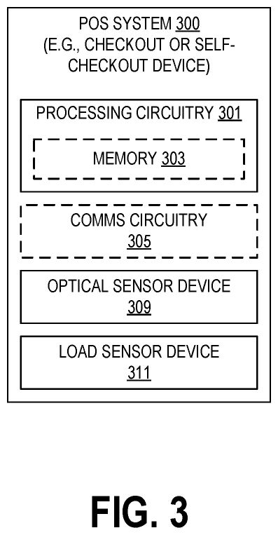

FIG. 2 illustrates another embodiment of a POS system or device 200 in accordance with various aspects as described herein. In FIG. 2, the device 200 implements various functional means, units, or modules (e.g., via the processing circuitry 301 in FIG. 3, via the processing circuitry 501 in FIG. 5, via software code, or the like), or circuits. In one embodiment, these functional means, units, modules, or circuits (e.g., for implementing the method(s) described herein) may include for instance: an input/output interface circuit 201 operable to interface with input and output devices such as an optical sensor device 205 (e.g., camera), a load sensor device 207 (e.g., weight scale), or the like; a load obtain circuit 211 operable to obtain a load such as from the load sensor device 207; a load receive circuit 213 operable to receive, from the load sensor device 207, an indication that includes a load measurement; a weight change determination circuit 215 operable to determine that a weight change event has occurred based on the load measurement; an image capture determination circuit 217 operable to determine to capture an image of the target object; an image obtain circuit 219 operable to obtain an image; an image receive circuit 221 operable to receive an image such as from the optical sensor device 205; an object recognition circuit 223 operable to perform object recognition of the target object represented in the captured image based on the captured image, with the object recognition being performed independent of the focal distance at which the target object was captured by the optical sensor device; an object prediction circuit 225 operable to predict the target object based on the weight measurement of the target object to obtain one or more weight-based predicted objects and corresponding weight-based confidence levels; and an object identification circuit 227 operable to perform object classification or identification of the target object based on the one or more vision-based predicted objects and the corresponding vision-based confidence levels and the one or more weight-based predicted objects and the corresponding weight-based confidence levels.

FIG. 3 illustrates another embodiment of a POS system 300 in accordance with various aspects as described herein. In FIG. 3, the device 300 may include processing circuitry 301 that is operably coupled to one or more of the following: memory 303, network communications circuitry 305, an optical sensor device 309 (e.g., camera), a load sensor device 311, the like, or any combination thereof. The network communication circuitry 305 is configured to transmit or receive information to or from one or more other devices via any communication technology. The processing circuitry 301 is configured to perform processing described herein, such as by executing instructions stored in memory 303. The processing circuitry 301 in this regard may implement certain functional means, units, or modules. The optical sensor device 309 is operable to capture an image, and the load sensor device 311 is operable to measure a load of an object.

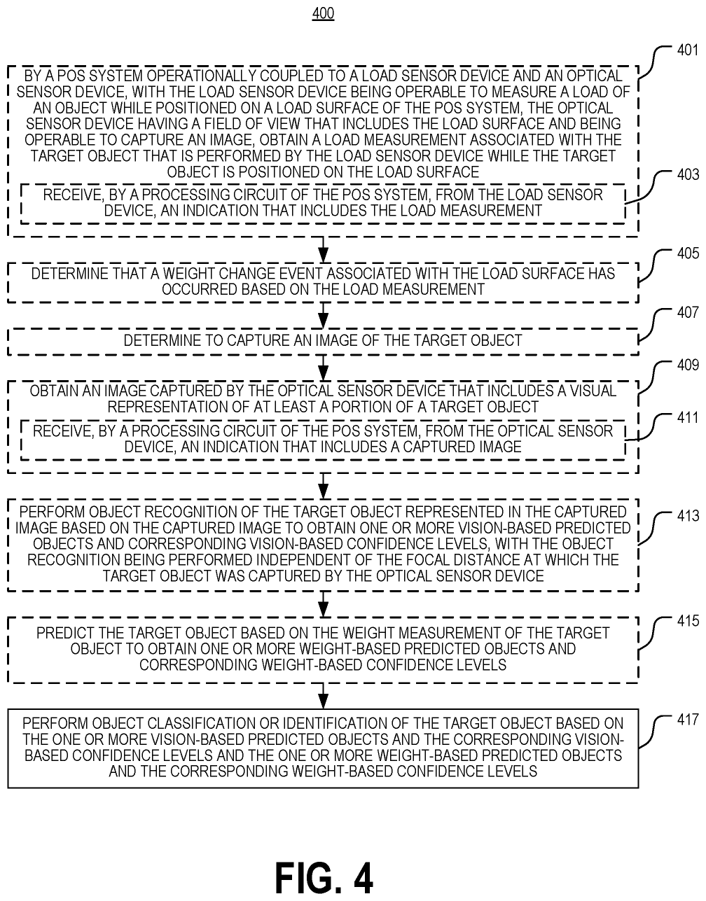

FIG. 4 illustrates one embodiment of a method 400 performed by a POS system 100, 200, 300, 500 of object classification or identification at point of sale in accordance with various aspects as described herein. In FIG. 4, the method 400 may start, for instance, at block 401 where it may include obtaining a load measurement associated with the target object that is performed by the load sensor device while the target object is positioned on the load surface. For instance, at block 403, the method 400 may include receiving, by a processing circuit of the POS system 100, 200, 300, 500, from the load sensor device, an indication that includes the load measurement. At block 405, the method 400 may include determining that a weight change event has occurred based on the load measurement. At block 407, the method 400 may include determining to capture an image of the target object. Further, the method 400 may include obtaining an image captured by the optical sensor device that includes a visual representation of at least a portion of a target object, as represented by block 409. For instance, the method 400 may also include receiving, by a processing circuit of the POS system, from the optical sensor device, image data associated with the captured image, as represented at block 411. At block 413, the method 400 may include performing object recognition of the target object represented in the captured image based on the captured image, with the object recognition being performed independent of the focal distance at which the target object was captured by the optical sensor device. The method 400 may further include predicting the target object based on the weight measurement of the target object to obtain one or more weight-based predicted objects and corresponding confidence levels, as represented by block 415. At block 417, the method 400 includes performing classification or identification of the target object based on the one or more vision-based predicted objects and the corresponding vision-based confidence levels and the one or more weight-based predicted objects and the corresponding weigh-based confidence levels.

FIG. 5 illustrates another embodiment of a POS system or device 500 in accordance with various aspects as described herein. In FIG. 5, device 500 includes processing circuitry 501 that is operatively coupled over bus 503 to input/output interface 505, artificial intelligence circuitry 509 (e.g., neural network circuit, machine learning circuit), network connection interface 511, power source 513, memory 515 including random access memory (RAM) 517, read-only memory (ROM) 519 and storage medium 521, communication subsystem 531, and/or any other component, or any combination thereof.

The input/output interface 505 may be configured to provide a communication interface to an input device, output device, or input and output device. The device 500 may be configured to use an output device via input/output interface 505. An output device 561 may use the same type of interface port as an input device. For example, a USB port or a Bluetooth port may be used to provide input to and output from the device 500. The output device may be a speaker, a sound card, a video card, a display, a monitor, a printer, an actuator, a transducer 575 (e.g., speaker, ultrasound emitter), an emitter, a smartcard, another output device, or any combination thereof. The device 500 may be configured to use an input device via input/output interface 505 to allow a user to capture information into the device 500. The input device may include a scanner device 561 (e.g., optical scanner device), a touch-sensitive or presence-sensitive display 563, an optical sensor device 575 (e.g., camera), a load sensor (e.g., weight sensor), a microphone, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical or image sensor, an infrared sensor, a proximity sensor, a microphone, an ultrasound sensor, another like sensor, or any combination thereof. As shown in FIG. 500, the input/output interface 505 can be configured to provide a communication interface to components of the POS system 100 such as the scanner associated with the scanner window 115, the scanner 116, a scale associated with the load surface 114, the display device 118, touchscreen 118, the payment processing mechanism 122, the printer 124, the coupon slot mechanism 125, the cash acceptor mechanism 126, light emitting devices 130, keyboard, keypad, card reader, the like, or any combination thereof.

In FIG. 5, storage medium 521 may include operating system 523, application program 525, data 527, the like, or any combination thereof. In other embodiments, storage medium 521 may include other similar types of information. Certain devices may utilize all of the components shown in FIG. 5, or only a subset of the components. The level of integration between the components may vary from one device to another device. Further, certain devices may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In FIG. 5, the artificial intelligence circuitry 509 may be configured to learn to perform tasks by considering examples such as performing object detection, object recognition, object classification or identification, or the like. In one example, a first artificial intelligence circuitry is configured to perform object recognition based on an image. Further, a second artificial intelligence circuitry is configured to perform object classification or identification. In FIG. 5, the network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers. The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the storage medium 521 may be configured to include an operating system 523, an application program 525 such as web browser, web application, user interface, browser data manager as described herein, a widget or gadget engine, or another application, and a data file 527. The storage medium 521 may store, for use by the device 500, any of a variety of various operating systems or combinations of operating systems.

The storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The storage medium 521 may allow the device 500a-b to access computer-executable instructions, application programs or the like, stored on transitory or non-transitory memory media, to off-load data, or to upload data. An article of manufacture, such as one utilizing a communication system may be tangibly embodied in the storage medium 521, which may comprise a device readable medium.

The processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software, or firmware, or alternatively may be implemented separately.

In FIG. 5, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the device 500a-b.

The features, benefits and/or functions described herein may be implemented in one of the components of the device 500 or partitioned across multiple components of the device 500. Further, the features, benefits, and/or functions described herein may be implemented in any combination of hardware, software, or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method is performed by a POS system operationally coupled to a load sensor device and an optical sensor device, with the load sensor device being operable to measure a load of an object while positioned on a load surface of the POS system and the optical sensor device having a field of view associated with the load surface and operable to capture an image. The method includes obtaining an image captured by the optical sensor device that includes a visual representation of at least a portion of a target object and a load measurement associated with the target object that is performed by the load sensor device while the target object is positioned on the load surface to enable object classification or identification of the target object based on both a recognition of the target object represented in the captured image that is independent of the focal distance at which the target object was captured by the optical sensor device and a prediction of the target object from the load measurement associated with the target object.

In another exemplary embodiment, the method further includes receiving, by a processing circuit of the POS system, from the load sensor device, an indication that includes the load measurement.

In another exemplary embodiment, the method further includes receiving, by a processing circuit of the POS system, from the optical sensor device, an indication that includes the captured image.

In another exemplary embodiment, the method further includes determining to capture an image of the target object responsive to determining that a weight change event has occurred based on the load measurement. In addition, the method further includes sending, by the processing circuit of the POS system, to the optical sensor device, an indication that includes a request to capture an image.

In another exemplary embodiment, the method further includes performing object recognition of the target object represented in the captured image based on the captured image, with the object recognition being performed independent of the focal distance at which the target object was captured by the optical sensor device.

In another exemplary embodiment, the method further includes sending, by a processing circuit of the POS system, to an artificial intelligence circuit, an indication that includes a request to perform the object recognition of the target object represented in the captured image based on the captured image, with the artificial intelligence circuit being trained on a set of training images of a certain object that is configured to enable the classification or identification of the certain object independent of the focal distance at which the certain object was captured by the optical sensor device. In addition, the method further includes receiving, by the processing circuit of the POS system, from the artificial intelligence circuit, an indication that includes one or more visual-based predicted objects and corresponding visual-based confidence levels.

In another exemplary embodiment, the set of training images of the certain object are captured by an optical sensor device at a certain distance from the certain object, with the certain distance corresponding to a distance in which the optical sensor device captures an image of the target object while positioned on the load surface.

In another exemplary embodiment, the method further includes sending, by the POS system, to a network node having an artificial intelligence circuit, an indication that includes a request to perform the object recognition of the target object represented in the captured image based on the captured image. Further, the artificial intelligence circuit is trained on a set of training images of a certain object. The set of training images of the certain object is configured to enable the classification or identification of the certain object independent of the focal distance at which the certain object was captured by an optical sensor device. The method further includes receiving, by the POS system, from the network node, an indication that includes one or more visual-based predicted objects and corresponding visual-based confidence levels.

In another exemplary embodiment, the method further includes recognizing the target object based on the captured image, with the recognition being performed independent of the focal distance at which the target object was captured by the optical sensor device to obtain one or more vision-based predicted objects and corresponding vision-based confidence levels.

In another exemplary embodiment, the method further includes predicting the target object based on the weight measurement of the target object to obtain one or more weight-based predicted objects and corresponding weight-based confidence levels.

In another exemplary embodiment, the method further includes performing classification or identification of the target object based on one or more vision-based predicted objects and corresponding vision-based confidence levels and one or more weight-based predicted objects and corresponding weight-based confidence levels.

In another exemplary embodiment, the method further includes recognizing the target object based on the captured image to obtain one or more vision-based predicted objects and corresponding vision-based confidence levels, with the recognition being performed independent of the focal distance at which the target object was captured by the optical sensor device. The method further includes predicting the target object based on the weight measurement of the target object to obtain one or more weight-based predicted objects and corresponding weight-based confidence levels. In addition, the method further includes performing classification or identification of the target object based on the one or more vision-based predicted objects and the corresponding vision-based confidence levels and the one or more weight-based predicted objects and the corresponding weight-based confidence levels.

In one exemplary embodiment, a POS system is operationally coupled to a load sensor device and an optical sensor device. The load sensor device is operable to measure a load of an object while positioned on a load surface of the POS system. Further, the optical sensor device has a field of view that includes the load surface and being operable to capture an image. The POS system further includes a memory with the memory containing instructions executable by the processing circuitry whereby the processing circuitry is configured to obtain an image captured by the optical sensor device that includes a visual representation of at least a portion of a target object and a load measurement associated with the target object that is performed by the load sensor device while the target object is positioned on the load surface to enable object classification or identification of the target object based on both a recognition of the target object represented in the captured image that is independent of the focal distance at which the target object was captured by the optical sensor device and a prediction of the target object from the load measurement associated with the target object.

In one exemplary embodiment, a POS system includes processing circuitry operably coupled to memory, a load sensor device operable to measure a load of an object while positioned on a load surface of the POS system, and an optical sensor device having a field of view associated with the load surface and operable to capture an image. The memory contains instructions executable by the processing circuitry whereby the processing circuitry is operative to obtain an image captured by the optical sensor device that includes a visual representation of at least a portion of a target object and a load measurement associated with the target object that is performed by the load sensor device while the target object is positioned on the load surface to enable object classification or identification of the target object based on both a recognition of the target object represented in the captured image that is independent of the focal distance at which the target object was captured by the optical sensor device and a prediction of the target object from the load measurement associated with the target object.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein.

Alternatively or additionally, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by a point of sale (POS) system operationally coupled to a load sensor device and an optical sensor device, with the load sensor device being operable to measure a load of an object while positioned on a load surface of the POS system, the optical sensor device having a field of view associated with the load surface and operable to capture an image,
obtaining an image captured by the optical sensor device that includes a visual representation of at least a portion of a target object and a load measurement associated with the target object that is performed by the load sensor device while the target object is positioned on the load surface to enable object classification or identification of the target object based on both an object recognition of the target object represented in the captured image and a prediction of the target object from the load measurement associated with the target object, with the object recognition being independent of the focal distance at which the target object was captured by the optical sensor device.

2. The method of claim 1, further comprising:
receiving, by a processing circuit of the POS system, from the load sensor device, an indication that includes the load measurement.

3. The method of claim 1, further comprising:
receiving, by a processing circuit of the POS system, from the optical sensor device, an indication that includes the captured image.

4. The method of claim 1, further comprising:
determining to capture an image of the target object responsive to determining that a weight change event has occurred based on the load measurement; and
sending, by the processing circuit of the POS system, to the optical sensor device, an indication that includes a request to capture the image.

5. The method of claim 1, further comprising:
performing object recognition of the target object represented in the captured image based on the captured image, with the object recognition being performed independent of the focal distance at which the target object was captured by the optical sensor device.

6. The method of claim 5, wherein the step of performing object recognition further includes:
sending, by a processing circuit of the POS system, to an artificial intelligence circuit, an indication that includes a request to perform the object recognition of the target object represented in the captured image based on the captured image, with the artificial intelligence circuit being trained on a set of training images of a certain object that is configured to enable the classification or identification of the certain object independent of the focal distance at which the certain object was captured by the optical sensor device; and
receiving, by the processing circuit of the POS system, from the artificial intelligence circuit, an indication that includes one or more visual-based predicted objects and corresponding visual-based confidence levels.

7. The method of claim 6, wherein the set of training images of the certain object are captured by an optical sensor device at a certain distance from the certain object, with the certain distance corresponding to a distance in which the optical sensor device captures an image of the target object while positioned on the load surface.

8. The method of claim 1, wherein the step of performing object recognition further includes:
sending, by the POS system, to a network node having an artificial intelligence circuit, an indication that includes a request to perform the object recognition of the target object represented in the captured image based on the captured image, with the artificial intelligence circuit being trained on a set of training images of a certain object, with the set of training images being configured to enable the object classification or identification of the certain object independent of the focal distance at which the certain object was captured by the optical sensor device; and
receiving, by the POS system, from the network node, an indication that includes one or more visual-based predicted objects and corresponding visual-based confidence levels.

9. The method of claim 1, further comprising:
recognizing the target object based on the captured image to obtain one or more vision-based predicted objects and corresponding vision-based confidence levels, with the recognition being performed independent of the focal distance at which the target object was captured by the optical sensor device.

10. The method of claim 1, further comprising:
predicting the target object based on the weight measurement of the target object to obtain one or more weight-based predicted objects and corresponding weight-based confidence levels.

11. The method of claim 1, further comprising:
performing object classification or identification of the target object based on one or more vision-based predicted objects and corresponding vision-based confidence levels and one or more weight-based predicted objects and corresponding weight-based confidence levels.

12. The method of claim 1, further comprising:
object recognizing the target object based on the captured image to obtain one or more vision-based predicted objects and corresponding vision-based confidence levels, with the object recognition being performed independent of the focal distance at which the target object was captured by the optical sensor device;
predicting the target object based on the weight measurement of the target object to obtain one or more weight-based predicted objects and corresponding weight-based confidence levels; and
performing object classification or identification of the target object based on the one or more vision-based predicted objects and the corresponding vision-based confidence levels and the one or more weight-based predicted objects and the corresponding weight-based confidence levels.

13. A point of sale (POS) system, comprising:
with the POS system being operationally coupled to a load sensor device and an optical sensor device, with the load sensor device being operable to measure a load of an object while positioned on a load surface of the POS system, the optical sensor device having a field of view that includes the load surface and being operable to capture an image,
wherein the POS system further includes a memory, the memory containing instructions executable by the processing circuitry whereby the processing circuitry is configured to:
obtain an image captured by the optical sensor device that includes a visual representation of at least a portion of a target object and a load measurement associated with the target object that is performed by the load sensor device while the target object is positioned on the load surface to enable object classification or identification of the target object based on both an object recognition of the target object represented in the captured image and a prediction of the target object from the load measurement associated with the target object, with the object recognition being independent of the focal distance at which the target object was captured by the optical sensor device.

14. The POS system of claim 13, wherein the memory includes further instructions executable by the processing circuitry whereby the processing circuitry is configured to:
send, by a processing circuit of the POS system, to an artificial intelligence circuit, an indication that includes a request to perform the object recognition of the target object represented in the captured image based on the captured image, with the artificial intelligence circuit being trained on a set of training images of a certain object that is configured to enable the classification or identification of the certain object independent of the focal distance at which the certain object was captured by the optical sensor device;
receive, by the processing circuit of the POS system, from the artificial intelligence circuit, an indication that includes one or more vision-based predicted objects and corresponding vision-based confidence levels; and
wherein the set of training images are captured by an optical sensor device at a certain distance from the certain object, with the certain distance corresponding to a distance in which the optical sensor device captures an image of the target object while positioned on the load surface.

15. The POS system of claim 13, wherein the memory includes further instructions executable by the processing circuitry whereby the processing circuitry is configured to:
send, to a network node having an artificial intelligence circuit, an indication that includes a request to perform the object recognition of the target object represented in the captured image based on the captured image, with the artificial intelligence circuit being trained on a set of training images of a certain object that is configured to enable the classification or identification of the certain object independent of the focal distance at which the certain object was captured by the optical sensor device;
receive, from the network node, an indication that includes one or more visual-based predicted objects and corresponding visual-based confidence levels.

16. The POS system of claim 13, wherein the memory includes further instructions executable by the processing circuitry whereby the processing circuitry is configured to:
recognize the target object based on the captured image to obtain one or more vision-based predicted objects and corresponding confidence levels, with the recognition being performed independent of the focal distance at which the target object was captured by the optical sensor device.

17. The POS system of claim 13, wherein the memory includes further instructions executable by the processing circuitry whereby the processing circuitry is configured to:
predict the target object based on the weight measurement of the target object to obtain one or more weight-based predicted objects and corresponding confidence levels.

18. The POS system of claim 13, wherein the memory includes further instructions executable by the processing circuitry whereby the processing circuitry is configured to:
perform classification or identification of the target object based on one or more vision-based predicted objects and corresponding vision-based confidence levels and one or more weight-based predicted objects and corresponding weight-based confidence levels.

19. The POS system of claim 13, wherein the memory includes further instructions executable by the processing circuitry whereby the processing circuitry is configured to:
object recognize the target object based on the captured image to obtain one or more vision-based predicted objects and corresponding vision-based confidence levels, with the object recognition being performed independent of the focal distance at which the target object was captured by the optical sensor device;
predict the target object based on the weight measurement of the target object to obtain one or more weight-based predicted objects and corresponding weight-based confidence levels; and
perform classification or identification of the target object based on the one or more vision-based predicted objects and the corresponding vision-based confidence levels and the one or more weight-based predicted objects and the corresponding weight-based confidence levels.

20. A point of service (POS) system, comprising:
a load sensor device operable to measure a load of an object while positioned on a load surface of the POS system;
optical sensor device having a field of view associated with the load surface and operable to capture an image; and
a processing circuitry and a memory containing instructions executable by the processing circuitry whereby the processing circuitry is operative to:
obtain an image captured by the optical sensor device that includes a visual representation of at least a portion of a target object and a load measurement associated with the target object that is performed by the load sensor device while the target object is positioned on the load surface to enable object classification or identification of the target object based on both an object recognition of the target object represented in the captured image and a prediction of the target object from the load measurement associated with the target object, with the object recognition being independent of the focal distance at which the target object was captured by the optical sensor device.
